(19) United States
(12) Patent Application Publication
(10) Pub. No.: US 2016/0027163 A1
(43) Pub. Date: Jan. 28, 2016

(54) SYSTEMS AND METHODS FOR LOADING MEDICATIONS IN MEDICATION STORAGE DEVICES

(71) Applicant: MedSentry, Inc., Westborough, MA (US)

(72) Inventors: David BEAR, Wellesley, MA (US); Adam Robert Wallen, Swampscott, MA (US)

(21) Appl. No.: 14/735,302

(22) Filed: Jun. 10, 2015

Related U.S. Application Data
(60) Provisional application No. 62/011,172, filed on Jun. 12, 2014.

(51) Int. Cl. G06T 7/00; H04N 5/225; G06K 9/62; G06F 19/00

(52) U.S. Cl. CPC G06T 7/001; G06F 19/3462; H04N 5/2256; G06K 9/6201

(57) ABSTRACT

A medication loading system includes a mask including a first portion and a second portion. The first portion includes a plurality of receptacles configured to receive medication. The second portion includes a plurality of openings and is movable relative to the first portion between a first and a second configuration. In the first configuration, the plurality of receptacles are obstructed by the second portion. In the second configuration, the plurality of receptacles are in communication with a medication storage device through the plurality of openings to allow the medication to fall through the opening into a dose container of the medication storage device. The medication loading system also includes an imaging system configured to capture an image of the mask and operative to determine if (a) the medication is loaded in the correct receptacle, and (b) the correct medication is loaded in one or more of the plurality of receptacles.

### CROSS REFERENCE TO RELATED APPLICATIONS

This application claims priority to and the benefit of U.S. Provisional Application No. 62/011,172, filed Jun. 12, 2014 and entitled “Systems and Methods for Loading Medications in Medication Storage Devices,” the disclosure of which is hereby incorporated by reference in its entirety.

### BACKGROUND

Embodiments described herein relate generally to systems and methods for loading medication storage devices, and in particular to medication loading systems for accurately loading medication storage devices with a regimen of prescribed medications.

Adherence is commonly defined as the extent to which a patient complies with a clinician's recommended treatment regimen (e.g., by taking all and only prescribed medications). Medication non-adherence contributes to 125,000 deaths annually in the United States, leads to 10-25% of hospital and nursing home admissions, and costs $300 billion annually in excess medical expenses. Hospital costs due to patient non-adherence are estimated at $8.5 billion annually. With the recent intensive movement to cost sharing (e.g., Accountable Care Organizations), hospital systems face severe financial penalties for early re-hospitalizations based on medication non-adherence following discharge. Studies show that approximately 50% of the 2 billion prescriptions filled each year are not taken as prescribed. (J. A. Cramer et al., “How Often Is Medication Taken as Prescribed? A Novel Assessment Technique,” Journal of the American Medical Association (9 Jun. 1989)). Low adherence to prescribed treatments has been shown to undermine treatment benefits. (Sackett D L, Snow J C. The magnitude of adherence and non-adherence. In: Haynes R B, Taylor D W, Sackett D L, eds. Adherence in Health Care. Baltimore, Md.: Johns Hopkins University Press; 1979:11-22). While lethargy and oversight can contribute to lack of adherence to a prescription regimen, incorrect loading of medication storage devices is a relatively neglected cause of lack of adherence.

Thus, there is a need for systems, devices, and methods for accurately loading medications into medication storage devices to ensure adherence to a prescribed medication regimen.

### SUMMARY

Embodiments described herein relate generally to systems and methods for loading medication storage devices, and in particular to medication loading systems for accurately loading medication storage devices. In some embodiments, a medication loading system includes a mask comprising a first portion and a second portion. The first portion includes a plurality of receptacles configured to receive a medication. The second portion includes a plurality of openings. The second portion is movable relative to the first portion between a first configuration and a second configuration. In the first configuration, the plurality of receptacles are obstructed by the second portion. In the second configuration, the plurality of receptacles are in communication with a medication storage device through the plurality of openings to allow the medication to fall through the opening into a dose container of the medication storage device. The medication loading system also includes an imaging system configured to capture an image of the mask. The imaging system is operative to determine if (a) the medication is loaded in the correct receptacle, and (b) the correct medication is loaded in one or more of the plurality of receptacles.

### BRIEF DESCRIPTION OF THE DRAWINGS

FIG. 1 is a schematic illustration of a medication loading system, according to an embodiment.

FIG. 2 is a perspective view of a medication storage device disposed below a medication loading system that includes a mask including a first portion and a second portion, and an imaging system, according to an embodiment.

FIG. 3 is a perspective view of the first portion and the second portion of the mask shown in FIG. 2 separated from each other.

FIG. 4 is a top view of the mask of FIG. 2 in a first configuration.

FIG. 5 is a top view of the mask of FIG. 2 in an intermediate configuration.

FIG. 6 is a top view of the mask of FIG. 2 in a second configuration.

FIG. 7 is a schematic flow diagram of a method for manually loading a medication storage device using a medication loading system, according to an embodiment.

FIG. 8 is a schematic flow diagram of a method for automatically loading a medication storage device using a medication loading system and a robotic loader, according to an embodiment.

### DETAILED DESCRIPTION

Embodiments described herein relate generally to systems and methods for loading medication storage devices, and in particular to medication loading systems for accurately loading medication storage devices. A key component of adherence is the accurate filling of medication storage devices that are commonly used by patients to store the medications. Such devices generally include a plurality of dose containers, for example, plastic containers or blister packs arranged in, for example, a rectangular, circular, or any other shape or size array corresponding to days of the week and times of the day (e.g., morning, noon, evening, and night). The most commonly used array of dose containers in medication storage devices is 7 days by 4 possible dose times per day for a total of 28 dose containers. If a patient is prescribed eight different medications there are approximately 2²⁸×2³=2 billion possible variations of loading the medications into the dose containers. A broad and complex polypharmacy regimen is often prescribed for patients suffering from heart failure, transplantation, drug resistant infections, Parkinson's disease, dementia, mood disorders, schizophrenia, undergoing chemotherapy to treat cancer, or from multiple diseases. Thus, errors in loading the dose containers are not unexpected.

The loading of the medications into the medication storage device is often performed manually either at home by the patient, or at a hospital or retail pharmacy, such that accurate loading is solely dependent on the attentiveness and attention to detail of the person loading the medication storage device. For example, in conventional pharmacies the medications can be loaded in the medication storage device by a pharmacy technician. The loaded medications are then reviewed by a pharmacist to ensure accuracy, i.e. whether the correct medications are loaded in the medication storage device based on the prescription of record, and the correct medications are loaded in the correct dose container. Double checks by pharmacists are costly and slow for complex regimens, and are therefore rarely performed on multi-medication packages. Polymedication filling robots are expensive and complex, and are often limited to packing 5 or fewer pills per dose container because of computer vision requirements for segmentation and relatively non-obtunded views of individual pills (e.g., Pill Pack). Even with robotic filing, there is a requirement by many state's Board of Pharmacy for two independent pharmacists to review some fraction of multimedication dose compartments.

Recently, robotic loaders have been used for dispensing medications at pharmacies. Such robotic loaders are however, generally used for either delivering prepackaged medication from the pharmacy shelf to the counter, or to dispense individual medication into a tube or a vial. Robotic loaders may make mistakes in counting pills when loading medications in individual dose containers. While relatively harmless in vials of individual medication, such errors, for example, an extra anticoagulant tablet or the absence of a prescribed antiepileptic drug in specific dose containers could have severe medical consequences. Furthermore, once an error is made, it is difficult to correct in a dose container which may contain a plurality of medications, for example, about 15 medications.

Embodiments of the medication loading systems described herein provide for systematic loading of medication storage devices with the correct medications and the correct dose. Embodiments of the medication loading systems described herein provide several advantages including, for example: (1) serial identification of the medication to be loaded in the medication storage device using a barcode scan; (2) comparing identified medication with patient prescription to ensure correct medication will be loaded into the medication loading system and thereby, the medication storage device; (3) computerized visual identification of medications disposed on the medication loading system to ensure that the correct medication is being loaded, and the medication is loaded in the correct dose container; (4) loading of a plurality of medications sequentially into the medication storage device; and (5) compatibility with manual loading and current robotic loading operations. Embodiments of the medication loading systems described herein can be configured to load medications in any medication storage device, for example, medication storage devices that monitor and enhance patient adherence to a prescription drug regimen. Examples of such medication storage devices for monitoring and enhancing patient adherence to a prescribed dosage are described in U.S. Pat. No. 9,014,427, filed Jan. 18, 2013, entitled “Medication Storage Device and Method”, (also referred to as “the '427 patent”) the entire disclosure of which is incorporated herein by reference.

In some embodiments, a medication loading system can include a mask which includes a first portion and a second portion. The first portion includes a plurality of receptacles. Each of the plurality of receptacles is configured to receive a medication. The second portion includes a plurality of openings and is movable relative to the first portion between a first configuration and the second configuration. In the first configuration, the plurality of receptacles are obstructed by the second portion. In the second configuration the plurality of receptacles are in communication with a medication storage device below through the plurality of openings to allow the medication to fall through the opening into a dose container of the medication storage device. The system also includes an imaging system configured to capture an image of the mask, and is operative to determine if (a) the medication is loaded into the correct receptacle, and (b) the correct medication is loaded in one or more of the plurality of receptacles.

In some embodiments, a method includes retrieving a prescription information. A medication is identified to load in a medication loading system. A bar code on the medication container is scanned, and the medication in the medication container is identified. The method determines if the medication is correct, and which receptacles to load based on the prescription information. The medication is then transferred to the receptacles and an image of the medication loading system is captured. The method then determines if the medication is loaded into the correct receptacle and if the correct medication is loaded. Finally, the medication is transferred to a medication storage device. In some embodiments, the method also includes indicating the one or more receptacles which have to be loaded with the medication.

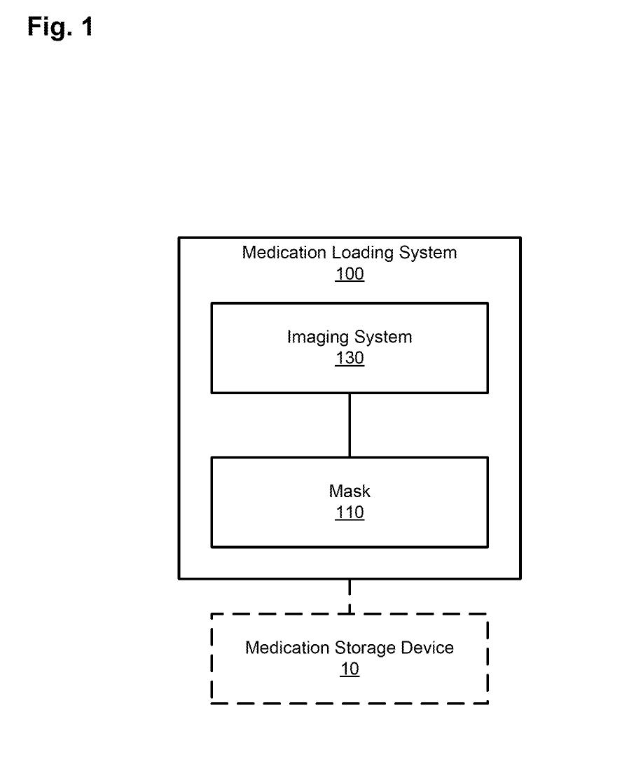

FIG. 1 is a schematic block diagram of a medication loading system 100 for loading medication storage devices. The medication loading system includes a mask 110 and an imaging system 130. The medication loading system 100 can be used for accurately and conveniently loading a medication storage device 10 with a plurality of medications in accordance with a patient prescription.

The mask 110 can include a first portion and a second portion. The first portion can include a plurality of receptacles each of which is configured to receive a medication. The first portion can, for example, resemble a tray that includes the plurality of receptacles. The receptacles can have any size or shape, for example, rectangle, rounded rectangle, square, circle, oval, elliptical, polygonal, or any other suitable shape. Any number of receptacles can be defined in the first portion. For example, in some embodiments, the plurality of receptacles can be arranged in an N by 7 array where N represents the number of scheduled doses per day. For example, in some embodiments, the first portion can include 28 receptacles arranged in a 7 days a week (e.g., Monday to Sunday) by 4 doses a day (e.g., morning, noon, evening, and night) array. In some embodiments, the first portion can include a plurality of receptacles arranged in a N×X configuration, where N is any number of days and X is any number of doses per day. Each of the plurality of receptacles are defined through the entire thickness of the first portion. Said another way, the receptacles do not include a base. Instead the second portion, for example, a surface of the second portion which is disposed adjacent to the first portion, obstructs the plurality of the receptacles thereby, forming a temporary base for the receptacles, as described herein. Each of the plurality of receptacles is configured to receive a medication. For example, a user or a robot can dispose a medication into a receptacle such that the medication is disposed on the surface of the second portion obstructing the plurality of receptacles and thereby, remains disposed in the receptacle. The medications can be disposed in the receptacles manually, for example, by a patient at home, a caregiver, a family member, a home care worker, a visiting nurse, or by a pharmacy technician or pharmacist at a retail or hospital pharmacy. In such embodiments, the first portion can include a lighting system configured to illuminate one or more of the plurality of receptacles to indicate which receptacles are to be loaded with the medication. For example, in some embodiments, light emitting diodes (LEDs) can be disposed adjacent to or proximate to each of the plurality of receptacles to illuminate the receptacle. In some embodiments, light sources (e.g., LEDs) included in a separate lighting system can be disposed above or below the first portion and configured to illuminate the receptacle to be loaded from above or below, respectively. In some embodiments, the medications can be disposed in the medication loading system 100 by a robotic loader such as, for example, the RM64 robotic loader by RxMedic Systems, Inc., or any other robotic loader. In some embodiments when automated filling a robotic loader is performed, the robot (e.g., RM64 robotic loader by RxMedic Systems, Inc.) can locate the individual medication within a library and then populate the receptacles as the mask 110 is moved on an XY movable table. In such embodiments, the lighting system might not be included in the first portion.

The second portion can be disposed adjacent to the first portion and below the first portion. The second portion includes a plurality of openings. The openings can be shaped and sized substantially similar to the plurality of receptacles and can be arranged in any suitable array or matrix corresponding to the plurality of receptacles. The second portion can be movable relative to the first portion between a first configuration and a second configuration. In the first configuration, the plurality of receptacles can be obstructed by the second portion. In the second configuration, the plurality of receptacles can be in communication with the medication storage device 10 below to allow the medication to fall through the opening into a dose container of the medication storage device 10. For example, the second portion can be slidably coupled to the first portion, for example, disposed on slide rails. In the first configuration, the plurality of receptacles can be obstructed by the surface of the second portion, as described herein. The second portion can then be moved (e.g., slid or rotated) relative to the first portion to move the second portion into the second configuration. In the second configuration, each of the plurality of openings can be disposed parallel or otherwise adjacent to a corresponding receptacle of the plurality of receptacles to allow the plurality of receptacles to be in communication with the medication storage device 10 which can, for example, be disposed below the second portion of the mask 110. The medication storage device 10 includes a plurality of dose containers, for example, plastic dose containers or blister packs arranged in a substantially similar array to the plurality of receptacles. Thus, in the second configuration, the medication can fall through the receptacles into a corresponding dose container of the medication storage device 10. In some embodiments, the medication storage device 10 can include any medication storage device described in the '427 patent incorporated by reference above.

In some embodiments, the second portion can include a protrusion (not shown) configured to be engaged by a user to move the second portion from the first configuration into the second configuration. For example, the protrusions can include a tab, a hook, a handle, or any other gripping mechanism which can be engaged by the user to move the second portion between the first and second configurations. In some embodiments, the second portion can include an automated linear translation mechanism which can include, for example, motors, gears, wheels, rack and pinion, hydraulic or air piston cylinders, lead screws, or any other suitable linear translation mechanism. In some embodiments, a biasing member can be coupled to the second portion. The biasing member can be configured to be biased in the second configuration and to urge the second portion into the first configuration, for example, when a force acting on the second portion, and maintaining the second portion in the second configuration, is removed

In some embodiments, the mask 110 can also include a retrieval mechanism configured to allow retrieval of a medication disposed in an incorrect receptacle. For example, in some embodiments, the mask 110 can include a third portion disposed below and adjacent to the second portion. The third portion can, for example, include one or more cavities configured to receive an incorrect medication loaded into the any of the plurality of receptacles. The third portion can also include a plurality of apertures to allow a medication to allow the plurality of openings to be in communication with the medication storage device through the plurality of openings and the plurality apertures. Expanding further, in a first configuration, the plurality of receptacles can be obstructed by the second portion. If a correct medication is loaded into a receptacle of the plurality of receptacles, the second portion can be moved into the second configuration. In the second configuration, the plurality of receptacles can be in communication with the medication storage device through the plurality of openings of the second portion and the plurality of apertures of the third portion. If an incorrect medication is loaded into a receptacle of the plurality of the receptacles, then the third portion can be moved relative to the first portion and a second portion into a third configuration to receive the medication falling through the opening into a cavity of the plurality of cavities included in the third portion, which can then be retrieved. For example, if an incorrect medication is loaded in a receptacle, the third portion can be moved into the third configuration such that each cavity of the plurality of cavities is disposed below, parallel, or otherwise adjacent to a corresponding receptacle of the plurality of receptacles. The second portion can then be moved into the second configuration such that the plurality of receptacles are in communication with the plurality of cavities of the third portion via the plurality of openings of the second portion. This can allow the incorrect medication to fall through the opening into the cavity. The third portion can be moved, slid out, or removed from underneath the third portion to retrieve the incorrectly loaded medication. In some embodiments, the third portion can include a centrally located cavity in communication with the plurality of cavities via a plurality of channels. In such embodiments, the incorrectly loaded medication can be communicated from the cavity receiving the incorrectly loaded medication to the central cavity for collection and removal.

The imaging system 130 is configured to capture an image of the mask 110. The imaging system is also operative to determine if (a) the medication is loaded in the correct receptacle, and (b) the correct medication is loaded in one or more of the plurality of receptacles. In some embodiments, the imaging system 130 can include a smartphone, tablet computer, a video camera, or any other image capture device. The imaging system 130 can be disposed and positioned to capture an image of each of plurality of receptacles defined by the mask 110 and thereby, capture an image of the medication disposed in one or more of the receptacles. For example, the imaging system 130 can be configured to capture a single image of the first portion of the mask 110. The image can include visual information of each receptacle defined in the first portion and any medication disposed in any number of receptacles of the plurality of receptacles. The imaging system 130 can then use image processing software, for example, binning, Fast Fourier transforms, etc., to identify the receptacles in which the medication is disposed. In some embodiments, the imaging system 130 can be configured to capture a plurality of images such that each image of the plurality of images corresponds to a single receptacle defined by the first portion of the mask 110. In such embodiments, each image can be used to determine if the receptacle corresponding to the image is loaded with the medication or not. In some embodiments, the imaging system 130 can include a memory configured to store a database of images of all medications, for example, generic or branded medication, included in a prescription. The database can, for example, be configured to include images of all generic and branded variations of a single medication (e.g., Metformin, Lipitor, Lisinopril, Nexium, etc.) that can be provided by a pharmacy or otherwise medication provider for the same prescription. The memory can also be configured to store the prescription which can be cross referenced with the captured image to determine if the medication is loaded in the correct receptacle, and the correct medication is loaded in the correct receptacle. The imaging system 130 can also include a processor capable of elementary computer vision analysis. The processor can include algorithms configured to compare the captured images of the medication disposed in a receptacle with the database of images and the prescription. For example, the processor can be configured to access the memory to retrieve the prescription information stored in the memory. The processor can analyze the prescription information to determine which medications are prescribed and in which receptacles the medications need to be loaded for accurate dispensing into the dose containers of the medication storage device 10. As described herein, the database of images stored in the memory can include images of all branded or generic variations of a medication. Since a particular medication can be available in various sizes, shapes, color, or form factors, for example, tablet, gel, capsule, caplet, etc., including images of all different forms of the same medication (e.g., Metformin, Lipitor, Lisinopril, Nexium, etc.) in the database can ensure that the processor can identify which medication is loaded in the receptacle regardless of its form factor. Said another way, the processor can be configured to compare the captured image of the medication disposed in a receptacle with the stored images of all different available variations of the medication which is to be loaded in the receptacle, as determined from the retrieved prescription. If the captured image of the medication disposed in the receptacle matches an image of any variation of the medication which is to be loaded in the specific receptacle, the processor can determine that the correct medication is loaded in the receptacle. In some embodiments, the database of images of the medications can be obtained when the medication container is scanned. The scanning of the barcode can lead to an image of the medication contained within, for example, provided by a pharmacy management system (e.g., the Computer-Rx pharmacy management system). In such embodiments, the database of medication images can be stored only in the pharmacy management system such that the memory does not store any images of the medications. In this manner, the imaging system 130 can be operative to determine if (a) the medication is loaded in the correct receptacle, and (b) if the correct medication is loaded into one or more of the plurality of receptacles. In some embodiments, the imaging system 130 can include a display configured to visually inform a user which receptacle to load the medication in. For example, the imaging system (e.g., a smartphone or tablet) can display a computer generated image of the plurality of receptacles included in the first portion and indicate the one or more receptacles that have to be filled with the medication. In some embodiments, the imaging system 130 can be in communication with the lighting system as described herein and configured to urge the lighting system to illuminate the receptacle that has to be filled with the medication. In some embodiments, the imaging system 130 can also be configured to scan a barcode on a medication container and determine which medication is present in the medication container. In such embodiments, the imaging system 130 can be configured to compare the medication information determined from the barcode scan with the prescription information to determine if the correct medication is selected.

In some embodiments, the medication loading system 100 can be configured to accurately and rapidly load a plurality of medication storage devices simultaneously. For example, the mask 110 included in the medication loading system 100 can define any number of receptacles located in any suitable array, arrangement, or other configuration such that the medication loading system 100 can be configured to load a plurality of medication storage devices simultaneously. Expanding further, in some embodiments, the imaging system 130 can be configured to retrieve a plurality of prescriptions prescribed to different patients. In some embodiments, the plurality of prescriptions can be substantially similar to each other, i.e., include substantially the same medications prescribed for substantially similar dosage regimens. For example, many patients suffering from cardiovascular disease, neurological, or psychiatric disorders are prescribed similar medication regimens. In some embodiments, the plurality of prescriptions can be substantially different from each other. A first medication which can be included in at least a portion of the plurality of prescriptions can be loaded, for example, by a robotic loader, into one or more receptacles of the medication loading system 100. The imaging system 130 can capture an image of the mask 110 and compare the image with each of the plurality of prescriptions to determine that (a) the correct receptacles are loaded with the first medication corresponding to each of the plurality of medication storage devices, and (b) the first medication is correct, as described herein. The medication loading system 100 can then transfer the first medication corresponding to each of the plurality of prescriptions into a corresponding dose container or plurality of corresponding dose containers of one or more of the plurality of medication storage device, such that the first medication can be loaded into the plurality of medication storage devices simultaneously. The process can then be repeated with a second medication and so on, until each of the plurality of medication storage devices is loaded with a specific prescription among the plurality of prescriptions which corresponds to that medication storage device. In some embodiments, each of the plurality of medication storage devices can be a separate medication storage device, for example, any of the medication storage device described in the '427 patent. In such embodiments, the plurality of medication storage devices can be disposed in a predetermined arrangement corresponding to the arrangement of the receptacles included in the mask 110 of the medication loading system 100 (e.g., disposed adjacent to each other in a rectangular array). In this manner, each dose container included in each of the plurality of medication storage devices can be in communication with a corresponding receptacle of the mask 110 via the openings in the second configuration, as described herein. In some embodiments, the plurality of medication storage devices can be monolithically formed, loaded with the prescribed medications corresponding to the plurality of prescriptions, and then separated into individual medication storage devices. For example, a large strip of a blister pack can be loaded with a plurality of medications corresponding to a plurality of prescriptions simultaneously using the medication loading system 100. The strip of the blister packs can be then be separated into individual portions, such that each portion includes medications corresponding to a single prescription and thereby, forms an individual medication storage device.

Having described above various general principles, several exemplary embodiments of these concepts are now described. These embodiments are only examples, and many other configurations of a medication loading system are contemplated.

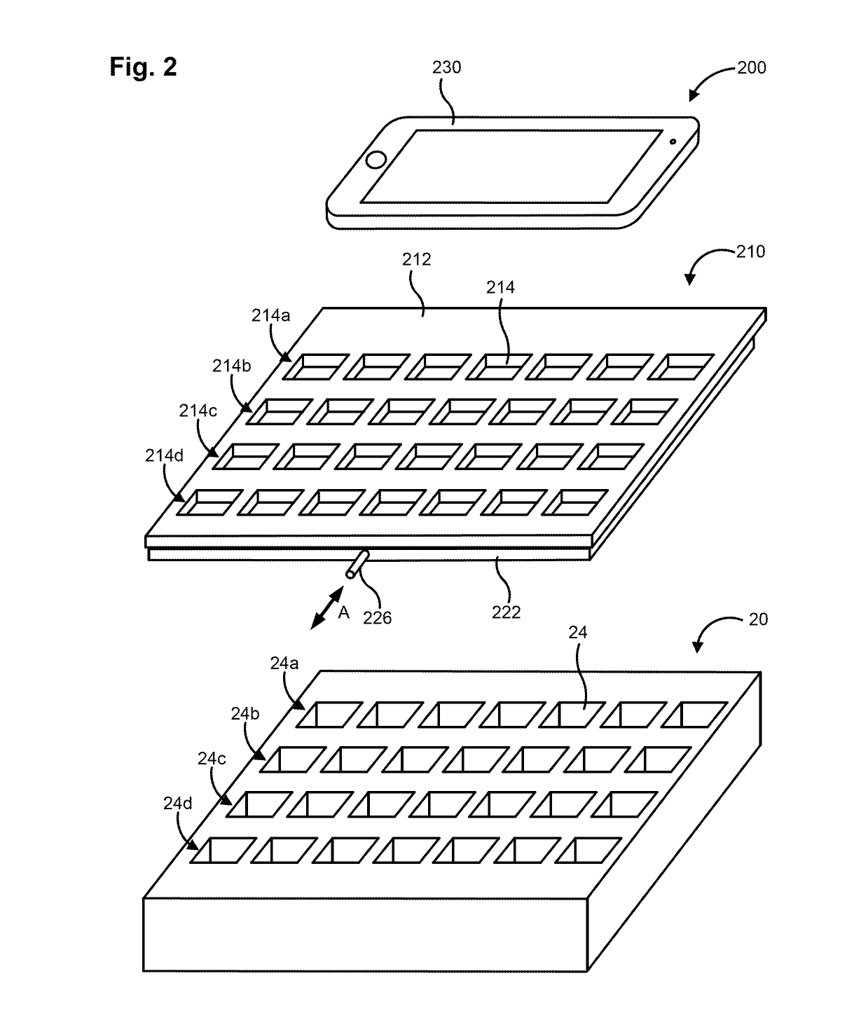

Referring now to FIGS. 2-6, in some embodiments, a medication loading system 200 includes a mask 210 and an imaging system 230. The medication loading system 200 is configured to accurately and conveniently load a medication M into a medication storage device 20. The medication storage device 20 includes a plurality of dose containers 24. The plurality of dose containers 24 are disposed in the medication storage device 20 in four rows of 7 dose containers 24 each. A first row 24a can correspond to a morning dose for each of the seven days of a week, a second row 24b can correspond to a noon dose, a third row 24c can correspond to an evening dose, and a fourth row 24d can correspond to a night dose for each of the seven days of the week.

The mask 210 includes a first portion 212 and a second portion 222. The first portion 212 includes a substantially flat member which can, for example, resemble a tray. The first portion 212 includes a plurality of receptacles 214 disposed in four rows of seven receptacles 214 each. A first row 214a can correspond to a morning dose for seven days of the week, a second row 214b can correspond to a noon dose, a third row 214c can correspond to an evening dose, and a fourth row 214d can correspond to a night dose for each of the seven days of the week. The first row of receptacles 214a is configured to be in communication with the first row of dose containers 24a of the medication storage device 20, the second row of receptacles 214b is configured to be in communication with the second row of dose container 24b, the third row of receptacles 214c is configured to be in communication with the third row of dose container 24c, and the fourth row of receptacles 214d is configured to be in communication with the fourth row of dose container 24d. While the receptacles 214 are shown as being rectangular in shape, each of the plurality of receptacles 214 can have any shape or size, for example, square, circular, oval, elliptical, polygonal, or any other shape or size. Furthermore, while shown as having a seven by four array, any number of receptacles 214 can be included in the first portion 212, for example, arranged in a N by 7 (as described before herein), in a N×X array where N is number of doses and X is number of days, or any other array. Each of the plurality of receptacles 214 are defined through the entire thickness of the first portion 212. Said another way, the receptacles 214 do not include a base. Instead the second portion 222, for example, a surface of the second portion which is disposed adjacent to the first portion, 222 obstructs the plurality of the receptacles 214 thereby, forming a temporary base for the receptacles 214, as described herein. Each of the plurality of receptacles 214 is configured to receive a medication M. For example, a user or a robot can dispose the medication M into a receptacle 214 of the plurality of receptacles 214 such that the medication M is disposed on the surface of the second portion 222 obstructing the plurality of receptacles 214 and thereby, remains disposed in the receptacle 214.

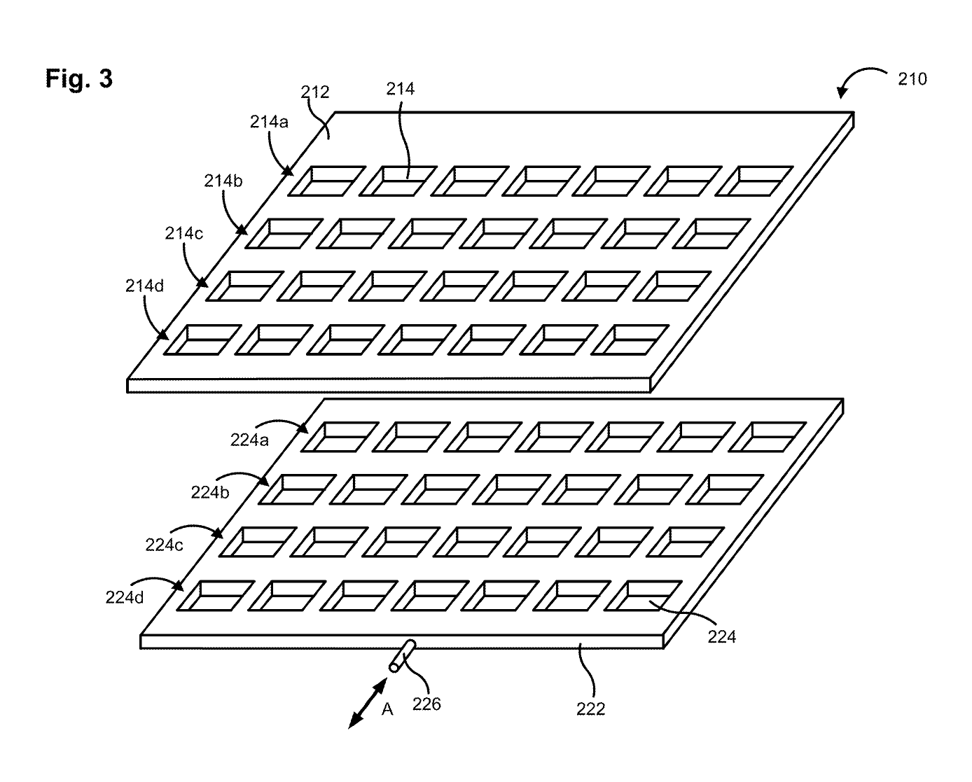

The second portion 222 is disposed adjacent to the first portion 212 and below the first portion 212, as shown in FIGS. 2 and 3. The second portion 222 includes a plurality of openings 224. The openings 224 are shaped and sized substantially similar to the plurality of receptacles 214 and are arranged in four rows of seven openings 224 each. The first row of openings 224a corresponds to the first row of receptacles 214a, the second row of openings 224b corresponds to the second row of receptacles 214b, the third row of openings 224c corresponds to the third row of receptacles 214c, and the fourth row of openings 224d corresponds to the fourth row of receptacles 214d. The second portion 222 includes a protrusion 226 disposed on the surface of the second portion 222. The second portion 222 is movable relative to the first portion 212 between a first configuration and a second configuration in a direction shown by the arrow A. For example, a user can engage the protrusion 226 to move the second portion 222 between the first configuration and the second configuration. The second portion 222 can be slidably coupled relative to the first portion 212, for example, mounted on slide rails. In the first configuration, the plurality of receptacles 214 are obstructed by the second portion 222 and in the second configuration, the plurality of receptacles 214 can be in communication with the dose containers 24 of the medication storage device 20 through the plurality of openings 224. Thus, the medication M disposed in a receptacle 214 of the plurality of receptacles 214 can fall through the openings 224 into a dose container 24 of the plurality of the dose containers 24 of the medication storage device 20, as described herein.

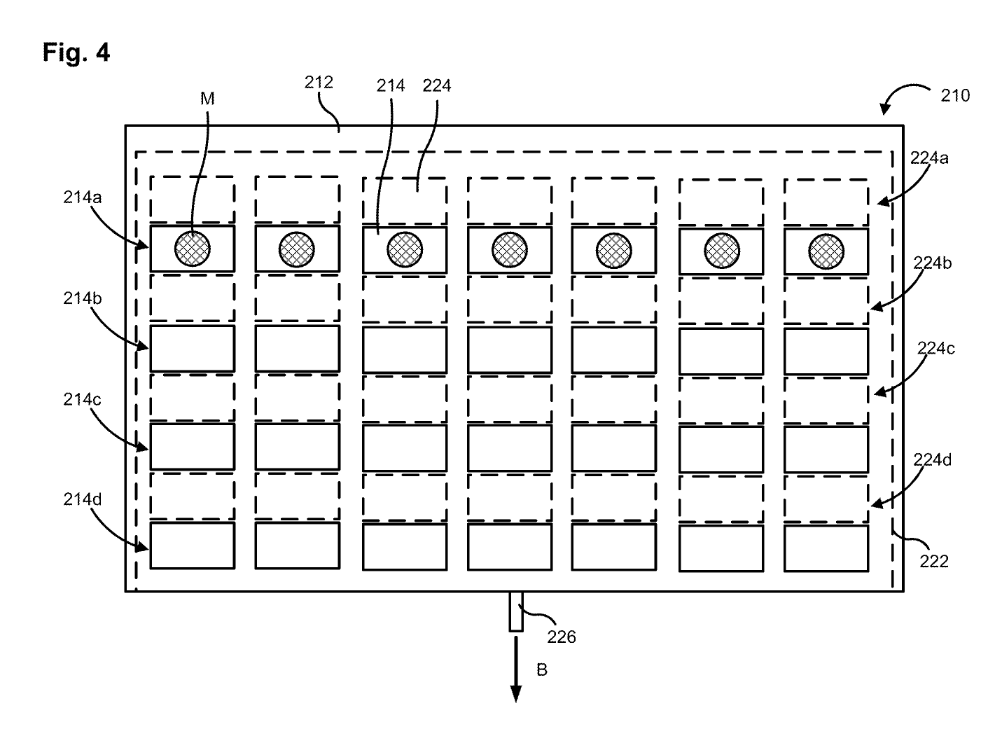

For example, FIG. 4 shows a top view of the mask in a first configuration. In the first configuration, the second portion 222 is disposed such that the plurality of openings 224 (shown by dotted lines) are staggered relative to the plurality of receptacles 214 and the plurality of receptacles 214 are obstructed by the surface of the second portion 222. A medication M can be disposed in each of the receptacles 214 included in the first row 214a of the receptacles 214. The medication M can be disposed in the receptacles 214 manually, for example, by a patient at home, a caregiver, a family member, a home care worker, a visiting nurse, or by a pharmacy technician or pharmacist at a retail or hospital pharmacy, or automatically using a robotic loader. The medication M can include a tablet, a capsule, a gel, or a caplet. In some embodiments, where the medication M is too large to fit into the dose container 24, for example, an inhaler, a parenteral, an injectable, a patch and/or a “lollipop” like medication stick, a medication reminder marker can be placed in the receptacle 214 in lieu of the medication M. The medication reminder marker can be a label, a coin shaped plastic chip, and/or a paper slip. In some embodiments, the medication reminder marker can have a color and label that matches the color or label on a prescribed medication.

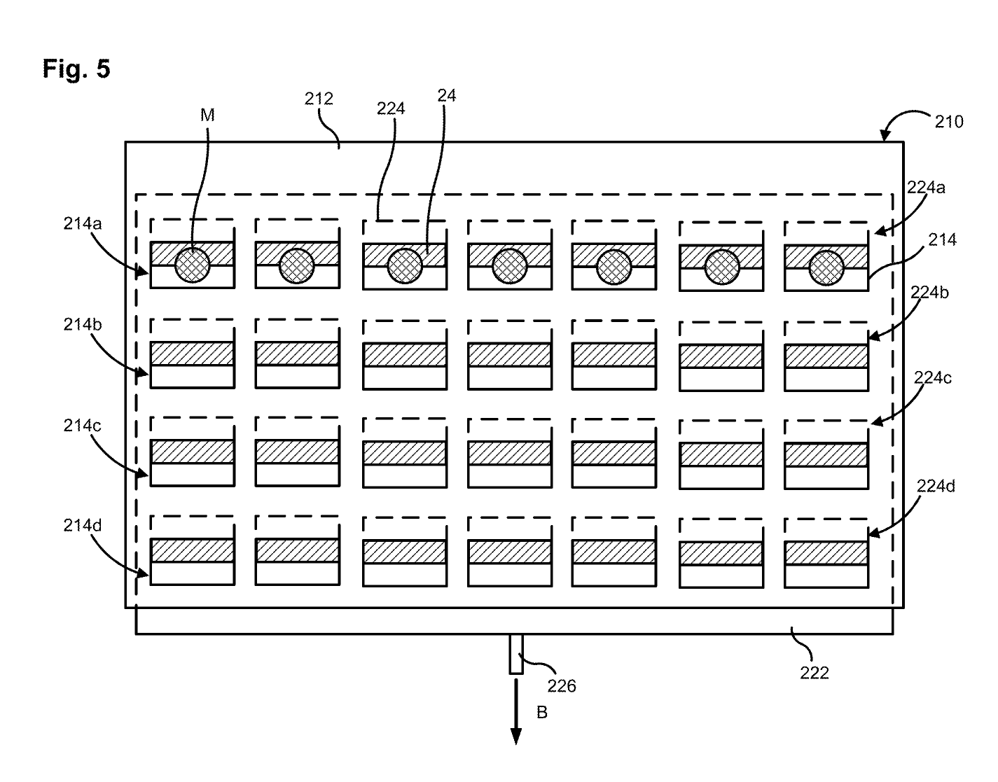

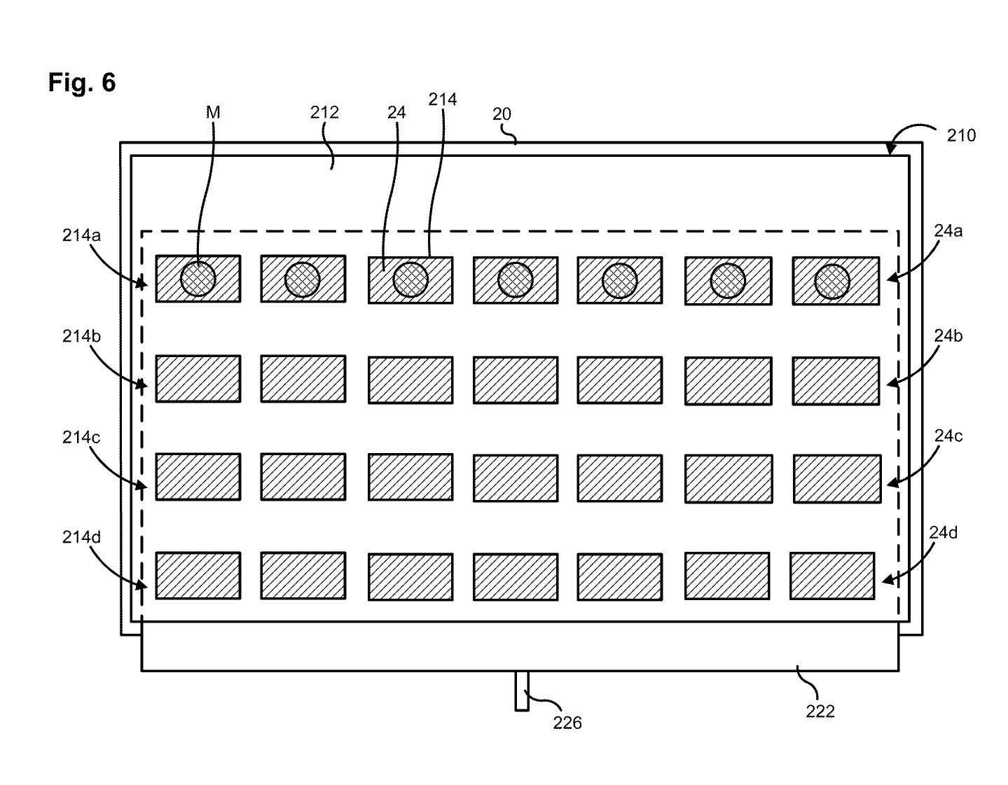

The imaging system 230, for example, a smartphone, can capture an image of the mask 110 and thereby, capture an image of the medication M disposed in the receptacles 214 included in the first row 214a. The imaging system 230 can then compare the captured image with stored images of the medication M, for example, a generic or branded medication, based on a prescription of a patient. The imaging system 230 can be substantially similar to the imaging system 130 described with respect to the system 100, and therefore, not described in further detail herein. The imaging system 230 can then make a determination whether the medication M is loaded in the correct receptacle 214, and the correct medication M is loaded in the receptacle 214 (e.g., as described with respect to the imaging system 130 included in the medication loading system 100). If the correct medication M is loaded in the receptacles 214 included in the first row 214a, a force in the direction shown by the arrow B can be exerted, for example, on the protrusion 226 to move the second portion 222 from the first configuration to the second configuration. FIG. 5 shows the second portion 222 in an intermediate configuration relative to the first portion 212 in which the plurality of receptacles 214 are partially obstructed by the second portion 222. The force can be maintained on the protrusion 226 until the second portion 222 is in the second configuration as shown in FIG. 6. In the second configuration, the plurality of openings 224 can be disposed immediately below the plurality of receptacles 214, such that the plurality of receptacles 214 are in communication with plurality of dose containers 24 of the medication storage device 20 via the plurality of openings 224. This can allow the medication M disposed in the receptacles 214 of the first row 214a, to fall into the corresponding dose containers 24 included in the first row 24a of the dose containers 24 of the medication storage device 20. Once the medication M is accurately disposed in the dose containers 24, the second portion 222 can be moved into the first configuration, a second medication included in the prescription can be loaded in the appropriate receptacles 214 based on the prescription information, and the process repeated. In this manner, any number of medications can be accurately and conveniently loaded in the medication storage device 20 using the medication loading system 200.

While shown as including a 7 by 4 array of receptacles 214 configured to load the mediation storage device 20 also having a 7 by 4 array of dose containers 24, in some embodiments, the first portion 214 can include any number of receptacles disposed in an N×X array, where N is number of doses and X is number of days, or any other array. Furthermore, while shown as being configured to load the medication storage device 20 individually, in some embodiments, the medication loading system 200 can include any number of receptacles 214 (and thereby openings 224) arranged in any suitable array or arrangement. In such embodiments, the medication loading system 100 can be configured to load a plurality of medication storage devices simultaneously, as described with respect to the medication loading system 100.

Any of the masks included in any of the medication loading systems, for example, the mask 110, or 210 included in the medication loading systems 100 and 200, respectively, or any other masks defined herein can be made from any suitable strong and rigid material. Such materials can include, for example, metals such as, for example, aluminum, or stainless steel, alloys, plastics, polymers, TEFLON®, carbon fiber, rubberized carbon, any other suitable material or combination thereof.

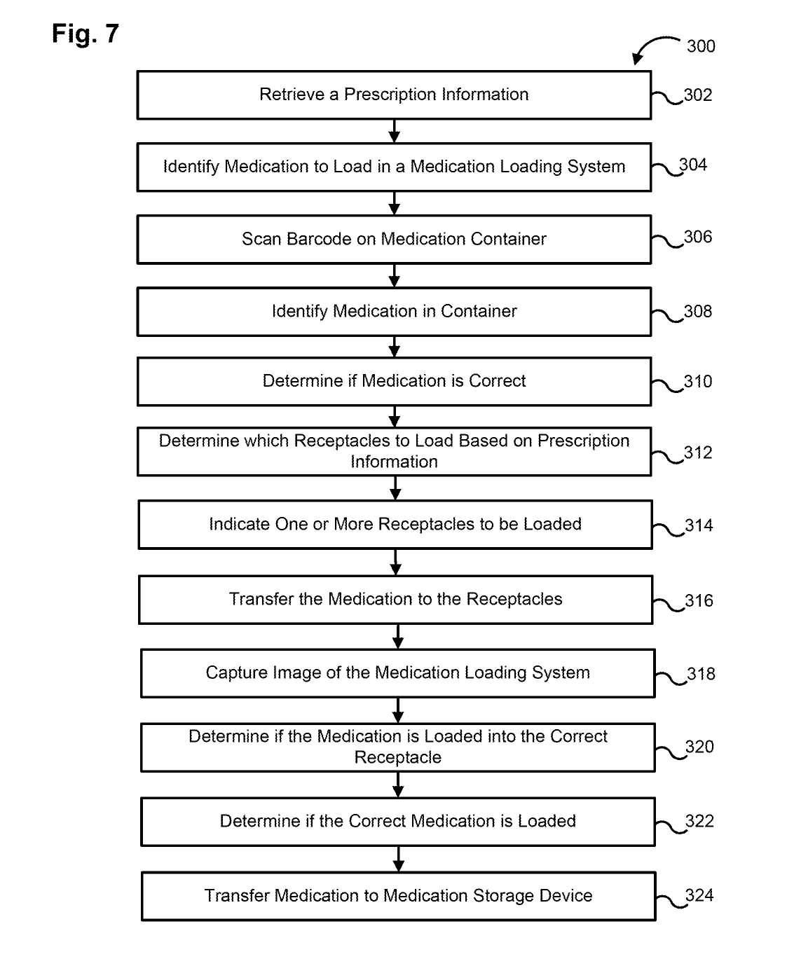

Embodiments of the medication loading systems described herein can be used with any method for accurately and conveniently loading a medication storage device. FIG. 7 shows a schematic flow diagram of a method 300 for manually loading a medication storage device, for example, the medication storage device 10, 20, or any other medication storage device described herein, using a medication loading system, for example, the medication loading system 100, 200, or any other medication loading system described herein. The method 300 includes retrieving prescription information, at 302. For example, the prescription information can be stored in a memory of an imaging system, for example, a smartphone, included in a medication loading system (e.g., the system 100, 200 or any other system described herein). In some embodiments, the prescription information can be retrieved from an external database, for example, a local computer, a remote server, a medication information record database, a pharmacy database, etc. which can be in electronic communication with the image processing system via a wired or a wireless connection. Next, the medication to load in a medication loading system is identified, at 304. For example, the prescription information can be analyzed to identify the various medications to be loaded, and the receptacles of the medication loading system (e.g., the receptacles 214 of the medication loading system 200) which are to be loaded with a particular medication included in the prescription.

A barcode on a medication container is scanned, at 306. For example, the imaging system of the medication loading system can be configured to scan the barcode on the medication container. In some embodiments, a separate barcode scanner can also be used. In some embodiments, the barcode can lead to the equivalent of an NDC code, giving reference images of the branded or generic medications disposed within the medication container (e.g., a pharmacy management system such as, for example, the ScriptPro pharmacy management system). The medication disposed in the medication container is identified, at 308. It is then determined if the medication is correct, at 310, i.e., the medication is correct based on an MD prescription. For example, the imaging system can identify the medication disposed in the medication container from the barcode disposed on the medication container. The imaging system can then compare the identified medication with the prescription information to determine if the medication is correct, i.e., is the medication included in the prescription information. If the medication is correct, the method 300 determines which receptacles to load based on the prescription information, at 312, i.e., the placement of the medications in the receptacles based as indicated by dosing instructions. For example, the imaging system can determine that a first row of receptacles of the medication loading system (e.g., the first row 214a of the plurality of receptacles 214 included in the medication loading system 200, described herein) has to be filled with the medication. The method 300 then indicates the one or more receptacles to be loaded, at 314. The indication can be intended for a human operator or a robot and can indicate the one or more receptacles which have to be loaded with each particular medication. For example, the medication loading system can then indicate to the user that all the receptacles of the first row of receptacles are to filled with the medication, for example, by illuminating the receptacles using a lighting system included in the medication loading system (e.g., the medication loading system 100 or 200 described herein), as described before herein. The medications are transferred to the receptacles, at 316. The medications can be transferred to the receptacles manually, for example, at home by a patient, a family member, a care giver, a nurse, or at a retail or hospital pharmacy by a pharmacy technician or a pharmacist. An image of the medication loading system is captured, at 318. For example, the imaging system can capture an image of the plurality of receptacles included in a first portion of the medication loading system (e.g., the receptacles 214 defined in the first portion 212 of the medication loading system 200). The method 300 then determines if the medication is loaded into the correct receptacle, at 320. The method 300 also determines if the correct medication is loaded, at 322. For example, the method can determine if the correct medication is being loaded into all and only those receptacles consistent with dosing, as obtained from the prescription information. The imaging system included in the medication loading system can compare the captured images of the medication disposed in the receptacles with the prescription information to determine if the medication is loaded in the correct receptacles, and if the correct medication is loaded in the receptacles. If the correct medication is loaded in the correct receptacles, the medication is then transferred to the medication storage device, at 324. For example, a second portion of the medication loading system (e.g., the second portion 222 include in the mask 210 of the medication loading system 200) can be moved from a first configuration in which the plurality of receptacles are obstructed by the second portion, to a second configuration in which the plurality of receptacles are in communication with the medication storage device via a plurality of corresponding openings defined in the second portion. In this manner, the medication loading system allows the medication to fall through the opening into a dose container of the medication storage device. In some embodiments, the method 300 also includes alerting the user if the incorrect medication is loaded in one or more of the receptacles. In some embodiments, the method 300 can further include alerting the user if the correct medication is loaded in one or more incorrect receptacles. For example, the imaging system can provide an audio, visual, or tactile alert to inform the user of the mistake thus, allowing the user to correct the mistake.

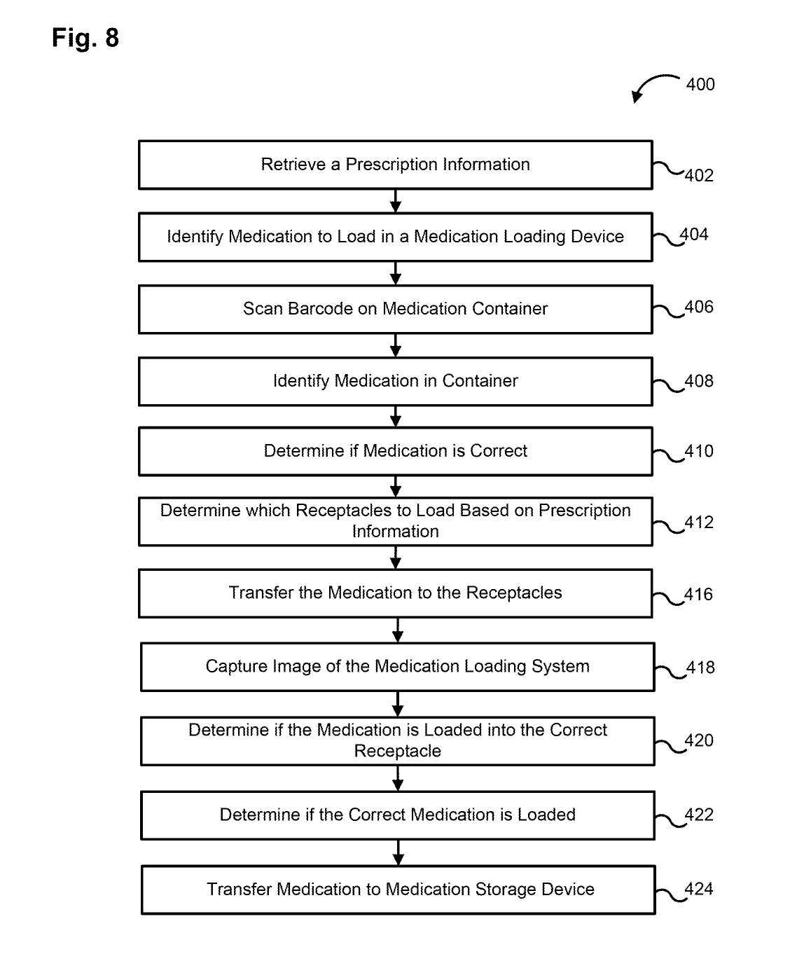

FIG. 8 shows a schematic flow diagram of a method 400 for loading a medication storage device, for example, the medication storage device 10, 20, or any other medication storage device described herein, using a medication loading system, for example, the medication loading system 100, 200, or any other medication loading system described herein. The method 400 can be used with a robotic loader, for example, the RM64 robotic loader by RxMedic Systems, Inc., or any other robotic loader. The method 400 includes retrieving a prescription information, at 402. For example, the prescription information can be stored in a memory of an imaging system, for example, a smartphone, included in a medication loading system (e.g., the system 100, 200 or any other system described herein). In some embodiments, the prescription information can be retrieved from an external database, for example, a local computer, a remote server, a medication information record database, a pharmacy database, etc. which can be in electronic communication with the image processing system via a wired or a wireless connection. Next, the medication to load in a medication loading system is identified, at 404. For example, the prescription information can be analyzed to identify the various medications to be loaded, and the receptacles of the medication loading system (e.g., the receptacles 214 of the medication loading system 200) which have to be loaded with a particular medication included in the prescription.

A barcode on a medication container is scanned, at 406. For example, the imaging system of the medication loading system can be configured to scan the barcode on the medication container. In some embodiments, a separate barcode scanner can also be used. The medication disposed in the medication container is identified, at 408. It is then determined if the medication is correct, at 410. For example, the imaging system can identify the medication disposed in the medication container from the barcode disposed on the medication container. The imaging system can then compare the identified with the prescription information to determine if the medication is correct, i.e., is the medication included in the prescription information. If the medication is correct, the method 400 determines which receptacles to load based on the prescription information, at 412. For example, the imaging system can determine that a first row of receptacles of the medication loading system (e.g., the first row 214a of the plurality of receptacles 214 included in the medication loading system 200, described herein) have to be filled with the medication. The medications are transferred to the receptacles, at 416. The medications can be transferred to the receptacles using a robotic loader, for example, the SP 200 robotic loader by ScriptPro, the RM64 robotic loader by RxMedic Systems, Inc., or any other robotic loader. An image of the medication loading system is captured, at 418. For example, the imaging system can capture an image of the plurality of receptacles included in a first portion of the medication loading system (e.g., the receptacles 214 defined in the first portion 212 of the medication loading system 200). The method 400 then determines if the medication is loaded into the correct receptacle, at 420. The method 400 also determines if the correct medication is loaded, at 422. For example, the imaging system included in the medication loading system can compare the captured image of the medication disposed in the receptacles with the prescription information to determine if the medication is loaded in the correct receptacles, and if the correct medication is loaded in the receptacles. If the correct medication is loaded in the correct receptacles, the medication is then transferred to the medication storage device, at 424. For example, a second portion of the medication loading system (e.g., the second portion 222 include in the mask 210 of the medication loading system 200) can be moved from a first configuration in which the plurality of receptacles are obstructed by the second portion, to a second configuration in which the plurality of receptacles are in communication with the medication storage device via a plurality of corresponding openings defined in the second portion. In this manner, the medication loading system allows the medication to fall through the opening into a dose container of the medication storage device.

While various embodiments of the system, methods and devices have been described above, it should be understood that they have been presented by way of example only, and not limitation. Where methods and steps described above indicate certain events occurring in certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

For example, although various embodiments have been described as having particular features and/or combination of components, other embodiments are possible having any combination or sub-combination of any features and/or components from any of the embodiments described herein. In addition, the specific configurations of the various components can also be varied. For example, the size and specific shape of the various components can be different than the embodiments shown, while still providing the functions as described herein.

1. A medication loading system, comprising:
a mask comprising a first portion and a second portion, the first portion including a plurality of receptacles, each receptacle of the plurality of receptacles configured to receive a medication, the second portion including a plurality of openings, the second portion movable relative to the first portion between a first configuration in which the plurality of receptacles are obstructed by the second portion, and a second configuration in which the plurality of receptacles are in communication with a medication storage device through the plurality of openings to allow the medication to fall through at least one of the plurality of openings into a dose container of the medication storage device; and
an imaging system configured to capture an image of the mask, the imaging system operative to determine if (a) the medication is loaded in the correct receptacle; and (b) the correct medication is loaded in one or more of the plurality of receptacles.

2. The system of claim 1, wherein the imaging system if further operative to determine if an incorrect medication is loaded in one or more of the plurality of receptacles.

3. The system of claim 1, wherein the plurality of receptacles are arranged in a N by 7 array where N is the number of scheduled doses per day.

4. The system of claim 1, wherein the plurality of receptacles are arranged in a N×X array where N is any number of days and X is any number of doses per day.

5. The system of claim 1, wherein the second portion includes a protrusion, the protrusion configured to be engaged by a user to move the second portion from the first configuration into the second configuration.

6. The system of claim 1, further comprising:
a retrieval mechanism configured to allow retrieval of a medication disposed in an incorrect receptacle, the retrieval mechanism including a third portion including a plurality of cavities configured to receive the medication from the incorrect receptacle via the opening, and allow retrieval of the medication from the cavity

7. The system of claim 1, wherein the first portion includes a lighting system disposed and configured to illuminate one or more of the plurality of receptacles to indicate which of the receptacles are to be loaded with the medication.

8. The system of claim 1, wherein the second portion is slidably coupled to the first portion.

9. The system of claim 1, wherein the medication storage device is a first medication storage device, and wherein in the second configuration, the plurality of receptacles are in communication with a second medication storage device such that the plurality of openings allow the medication to fall through the plurality of openings into the first medication storage device and the second medication storage device simultaneously.

10. The system of claim 1, wherein the imaging system includes a smartphone, tablet computer, a video camera, or another image capture device.

11. The system of claim 1, wherein the imaging system is configured to capture a single image of the plurality of receptacles of the first portion of the mask.

12. The system of claim 1, wherein the imaging system is configured to capture a plurality of images, such that each image of the plurality of images corresponds to a single receptacle of the plurality of receptacles.

13. The system of claim 1, wherein the imaging system includes a processor configured to compare the image of the mask with a prescription to determine if the medication is loaded in the correct receptacle.

14. The system of claim 1, wherein the imaging system includes a memory configured to store a database of images medications.

15. The system of claim 14, wherein the imaging system includes a processor configured to compare the image of the mask with a stored image in the database of images to determine if the correct medication is loaded in one or more of the plurality of receptacles.

16. A method, comprising;
retrieving a prescription information;
identifying a medication to load in a medication loading system;
scanning a bar code on a medication container;
identifying the medication in the medication container;
determining if the medication is correct;
determining which receptacles to load based on the prescription information;
transferring the medication to the receptacles;
capturing an image of the medication loading system;
determining if the medication is loaded into the correct receptacles;
determining if the correct medication is loaded; and
transferring the medication to a medication storage device.

17. The method of claim 16, further comprising:
indicating the one or more receptacles which have to be loaded with the medication.

18. The method of claim 17, wherein the indicating includes illuminating the one or more receptacles which have to be loaded with the medication.

19. The method of claim 16, further comprising:
alerting a user if an incorrect medication is loaded in one or more of the receptacles.

20. The method of claim 16, further comprising;
alerting a user if the correct medication is loaded in one or more incorrect receptacles.

21. The method of claim 16, wherein the determining if the medication is loaded into the correct receptacles and the determining if the correct medication is loaded include comparing the image of the medication loading system to a stored image of the medication and the prescription information.
